(19) United States
(12) Patent Application Publication
(10) Pub. No.: US 2020/0119770 A1
(43) Pub. Date: Apr. 16, 2020

(54) CONNECTION APPARATUS

(71) Applicant: eNFC Inc., Minato-ku Tokyo (JP)

(72) Inventor: Takanori WASHIRO, Minato-ku, Tokyo (JP)

(73) Assignee: eNFC Inc., Minato-ku Tokyo (JP)

(21) Appl. No.: 16/619,336

(22) PCT Filed: Jun. 8, 2018
(86) PCT No.: PCT/JP2018/022104

§ 371 Date: Dec. 4, 2019

(30) Foreign Application Priority Data
Jun. 8, 2017 (JP) 2017-113129

(51) Int. Cl. H04B 5/00; H04B 1/38

(52) U.S. Cl. CPC H04B 5/0075; H04B 1/38

(57) ABSTRACT

A connection apparatus includes a connection terminal connectable to an electronic device, a cable connected to the connection terminal a transceiver connected to the cable and configured to control transmission and reception of high-frequency signals or high-frequency power, a terminal line connected to the transceiver and having an electrical length of substantially 90 degrees, and a signal wire for electric field communication, the signal wire being connected from the transceiver to the ground of the cable. The connection apparatus is capable of easily adding an electric field communication function to an existing electronic device.

### CROSS-REFERENCE TO RELATED APPLICATION

The present application claims priority to and the benefit of Japanese Patent Application No. 2017-113129 filed Jun. 8, 2017, the entire contents of which are incorporated herein by reference.

### TECHNICAL FIELD

The present disclosure relates to a connection apparatus capable of adding an electric field communication function to an existing electronic device by being connected to the electronic device.

### BACKGROUND

A transmission apparatus for transmitting high-frequency signals or high-frequency power using electric field communication via a transmission medium is known. For example, patent literature (PTL) 1 discloses a transmission apparatus that includes a communication device and a terminal line with an electrical length of substantially 90 degrees. The transmission apparatus transmits high-frequency signals or high-frequency power to another transmission apparatus.

### CITATION LIST

### Patent Literature

PTL 1: JP2017-092539A

### SUMMARY

### Technical Problem

For example, if a hardware structure capable of executing the transmission function disclosed in PTL 1 is included in an electronic device to add the transmission function to the electronic device, the size of the electronic device may increase due to the hardware structure, and it may be necessary to rethink the arrangement of components in the electronic device. It may therefore be difficult to make the electronic device compact, or it may be difficult to embed the hardware structure due to design restrictions on the electronic device.

For example, if a user of an electronic device without a transmission function wishes to use the transmission function disclosed in PTL 1 on the electronic device, the user needs to newly purchase an electronic device having the transmission function. Newly purchasing an electronic device having the transmission function incurs a cost. It also wastes resources to discard the old electronic device after the electronic device having the transmission function is newly purchased.

The present disclosure has been conceived in light of these circumstances and provides a connection apparatus capable of easily adding an electric field communication function to an existing electronic device.

### Solution to Problem

To solve the aforementioned problem, a connection apparatus according to a first aspect includes:

a connection terminal connectable to an electronic device;

a cable connected to the connection terminal;

a transceiver connected to the cable and configured to control transmission and reception of high-frequency signals or high-frequency power;

a terminal line connected to the transceiver and having an electrical length of substantially 90 degrees; and

a signal wire for electric field communication, the signal wire being connected from the transceiver to a ground of the cable.

In a connection apparatus according to a second aspect, the connection terminal is insertable into the electronic device.

### Advantageous Effect

The connection apparatus according to the present disclosure is capable of easily adding an electric field communication function to an existing electronic device.

Other aims, features, and advantages of the present disclosure will become clear in the detailed description below, which is based on embodiments of the present disclosure and the appended drawings.

### BRIEF DESCRIPTION OF THE DRAWINGS

In the accompanying drawings:

FIG. 1 schematically illustrates an example of a connection apparatus according to an embodiment of the present disclosure;

FIG. 2 is a schematic view illustrating an example of the connection apparatus of FIG. 1 connected to an electronic device;

FIG. 3 is a schematic view illustrating an example of an electric field communication system using an electronic device to which the connection apparatus of FIG. 1 is connected;

FIG. 4 is a schematic view illustrating operations for electric field communication by the connection apparatus and electronic device of FIG. 3;

FIG. 5 schematically illustrates the function of a terminal device in

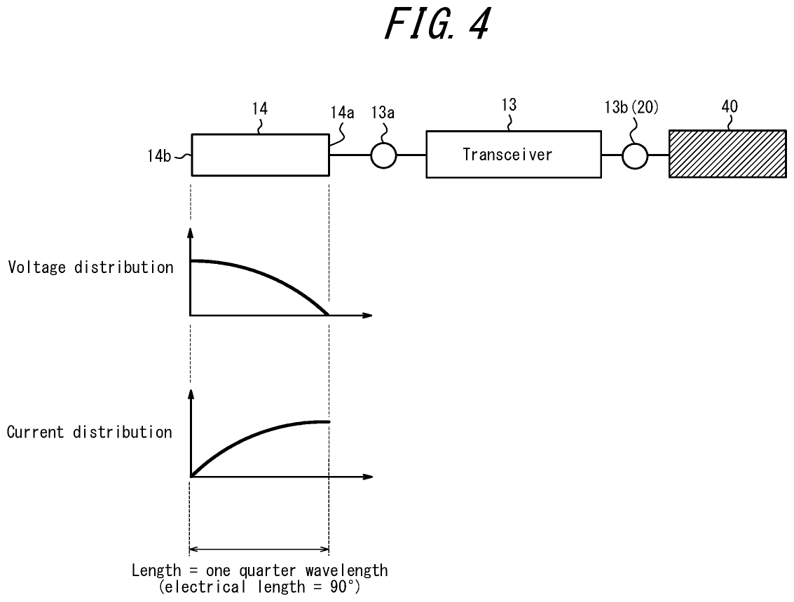

FIG. 4;

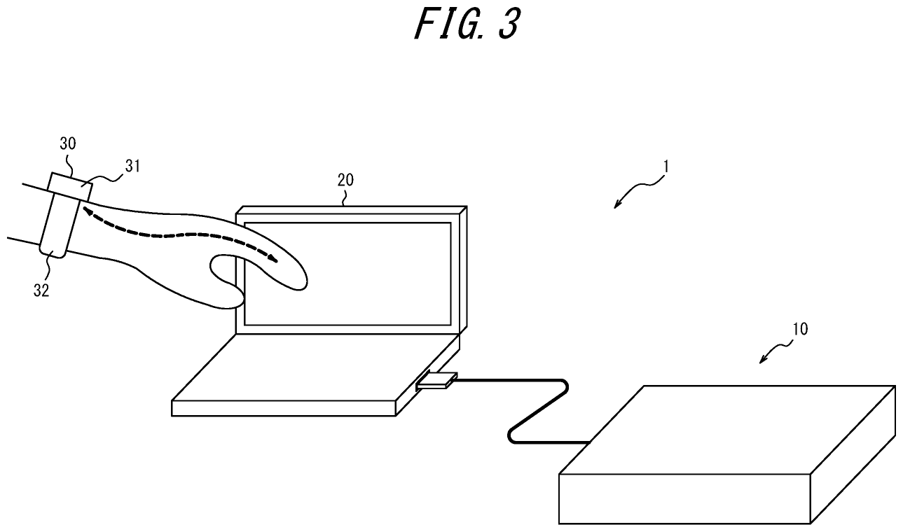

FIG. 6 is a functional block diagram illustrating an example of the schematic configuration of the body of the electric field communication terminal of FIG. 3;

FIG. 7 schematically illustrates the state in which an electric field communication terminal is coupled to a dielectric;

FIG. 8 schematically illustrates an example of a coupled state allowing electric field communication to be established between a connection apparatus and an electric field communication terminal;

FIG. 9 schematically illustrates an example of a coupled state in which electric field communication is not established between a connection apparatus and an electric field communication terminal;

FIG. 10 schematically illustrates an example of an electric field communication system configured by coupling an electric field communication terminal to a human body; and

FIG. 11 illustrates an example of operations by which an electronic device to which a connection apparatus is connected functions as an electric field antenna.

### DETAILED DESCRIPTION

Embodiments of the present disclosure are described below in detail with reference to the drawings.

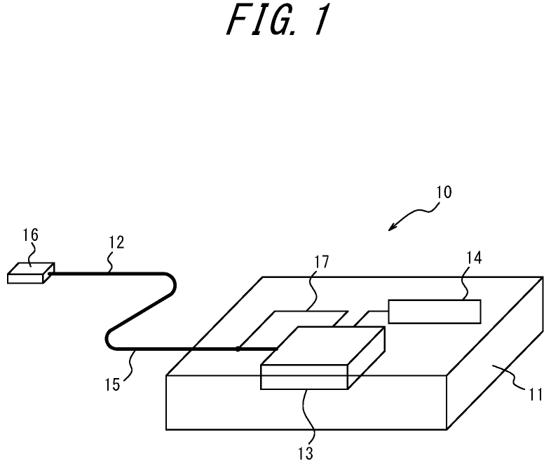

FIG. 1 schematically illustrates an example of a connection apparatus 10 according to an embodiment of the present disclosure. The connection apparatus 10 includes a body 11 and a connector 12. In FIG. 1, the internal configuration of the body 11 is also illustrated for the sake of explanation. The body 11 may, however, be configured so that the internal configuration cannot actually be seen directly from the outside.

The connection apparatus 10 is used after being connected to an electronic device, such as a personal computer (PC). The connection apparatus 10 can add an electric field communication function to an electronic device when connected to the electronic device. In the present embodiment, the electronic device is described as being a PC, and the connection apparatus 10 as being connected to a universal serial bus (USB) port of the electronic device.

The body 11 is a housing that protects the internal structural components. The body 11 may, for example, have a substantially cuboid shape but is not limited to being cuboid. The body 11 is, for example, made of resin or the like. The body 11 includes a transceiver 13 and a terminal line 14. The transceiver 13 is coupled electrically to the terminal line 14 via a first input/output terminal, described below. The transceiver 13 is connected to ground or a sealed line of a cable 15 via a signal wire 17 for electric field communication. While details are provided below, the transceiver 13 controls transmission and reception of high-frequency signals or high-frequency power based on a control signal from an electronic device. The terminal line 14 has an electrical length of substantially 90 degrees. Details on the terminal line 14 are provided below.

The connector 12 includes the cable 15 and a connection terminal 16. The connector 12 may, for example, be configured as a universal serial bus (USB) connector.

The cable 15 may, for example, be a well-known USB cable. For example, the cable 15 includes a wire core, a shield wire covering the wire core and connected to ground, and a coating for protecting the wire core. The wire core includes a signal wire for transmitting and receiving signals to and from an electronic device. The coating may, for example, be made of vinyl chloride. One end of the cable 15 is connected to the connection terminal 16, and the other end is connected to the transceiver 13. The ground or shield wire of the cable 15 is connected to the transceiver 13 in a manner allowing transmission of electric field signals from the transceiver 13 via the signal wire 17 for electric field communication.

The connection terminal 16 is, for example, a well-known USB terminal. The connection terminal 16 is configured to be insertable into the USB port of an electronic device.

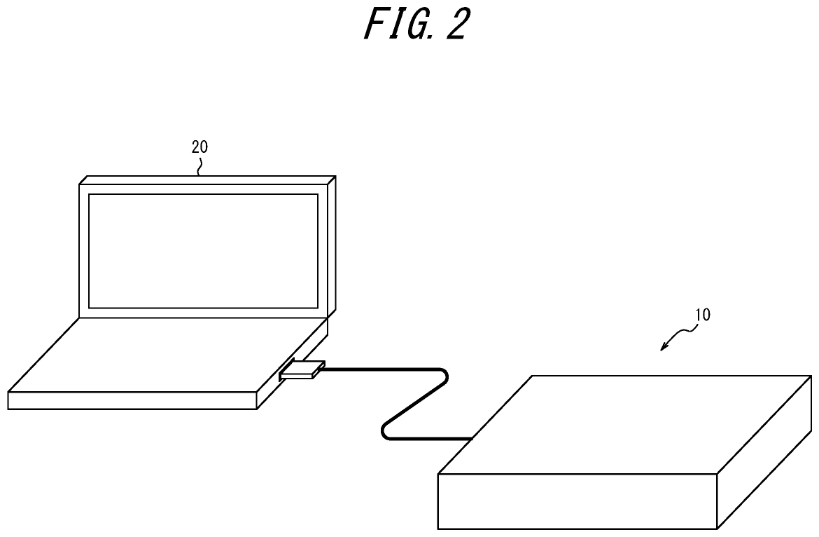

FIG. 2 is a schematic view illustrating an example of the connection apparatus 10 of FIG. 1 connected to an electronic device 20. As illustrated in FIG. 2, the connection apparatus 10 connects to the electronic device 20 by insertion of the connection terminal 16 into the electronic device 20. After the connection apparatus 10 is connected, the electronic device 20 functions as an electric field antenna for electric field communication using electric field signals. The principle by which the electronic device 20 functions as an electric field antenna is described below.

FIG. 3 is a schematic view illustrating an example of an electric field communication system 1 using the electronic device 20 to which the connection apparatus 10 of FIG. 1 is connected. The electric field communication system 1 includes the electronic device 20, the connection apparatus 10 connected to the electronic device 20, and an electric field communication terminal 30.

The electric field communication terminal 30 is, for example, used while worn by a user. The electric field communication terminal 30 is, for example, worn on the wrist, arm, or the like. The electric field communication terminal 30 is configured to be capable of electric field communication using electric field signals while being worn by the user.

The electric field communication terminal 30 includes a body 31 and a wearable portion 32. The body 31 includes functional components for the electric field communication terminal 30 to perform electric field communication. Details on the functional components of the body 31 are provided below. The wearable portion 32 is a mechanism for the user to maintain the electric field communication terminal 30 in a state of being worn. The wearable portion 32 is, for example, configured as a belt, wristband, or armband wearable by being wound around the user's wrist, arm, or the like. The wearable portion 32 is not, however, limited to being a belt and may be configured as any shape wearable by the user. The wearable portion 32 may, for example, be shaped as a ring that is wearable on the user's finger. In the present embodiment, the electric field communication terminal 30 is described as being worn on the user's wrist.

The electronic device 20 and the electric field communication terminal 30 perform electric field communication using a human body (user), which is a dielectric, as a transmission medium. In other words, electric field communication occurs when the user wearing the electric field communication terminal 30 touches the electronic device 20 that functions as an electric field antenna.

FIG. 4 is a schematic view illustrating operations for electric field communication by the connection apparatus 10 and the electronic device 20 of FIG. 3. In FIG. 4, the transceiver 13 is connected to a first input/output terminal 13a and a second input/output terminal 13b. The first input/output terminal 13a is provided between the transceiver 13 and the terminal line 14. The electronic device 20 and the ground or shield wire of the cable 15 function as the second input/output terminal 13b when electric field communication is performed in the electric field communication system 1.

The transceiver 13 controls transmission and reception of high-frequency signals or high-frequency power. When performing electric field communication, the transceiver 13 transmits and receives high-frequency signals (or high-frequency power) between 10 kHz and 10 GHz, for example. The first input/output terminal 13a is connected to the terminal line 14 that functions as a virtual ground. Details on the terminal line 14 are provided below.

The transceiver 13 is connected to the second input/output terminal 13b. The second input/output terminal 13b functions as a coupling electrode (electric field antenna) that couples with a dielectric. When the second input/output terminal 13b is coupled electrically to the transmission medium 40, which is constituted by a human body, electric field communication is established between the electronic device 20 to which the connection apparatus 10 is connected and the electric field communication terminal 30.

The terminal line 14 functioning as a virtual ground is now described. The first input/output terminal 13a is coupled electrically to the terminal line 14. The terminal line 14 is formed by a conductor, such as metal, or a dielectric. As an example, the transceiver 13 is described as transmitting high-frequency signals.

When the transceiver 13 transmits a high-frequency signal by electric field communication with the electric field communication terminal 30, current flows to the terminal line 14 from the first input/output terminal 13a of the transceiver 13 coupled to the terminal line 14. At the same time, current of the same magnitude as the current flowing to the terminal line 14 flows in the opposite direction from the second input/output terminal 13b to the transmission medium 40 constituted by a human body or the like. In this way, the transceiver 13 sends a high-frequency signal to the transmission medium 40.

The terminal line 14 has an electrical length of 90 degrees. An electrical length of 90 degrees means that the length of the line from an end 14a connected to the first input/output terminal 13a to the other end 14b is one quarter of the wavelength of the high-frequency signal to be transmitted. In other words, the phase of the high-frequency signal to be transmitted advances 90 degrees over the length from the end 14a connected to the first input/output terminal 13a to the other end 14b.

Consequently, the current that flows to the terminal line 14 side from the end 14a connected to the first input/output terminal 13a is subsequently reflected at the other end 14b of the terminal line 14 and returns to the end 14a connected to the first input/output terminal 13a, thereby traversing a distance of half a wavelength. The phase thus advances 180 degrees.

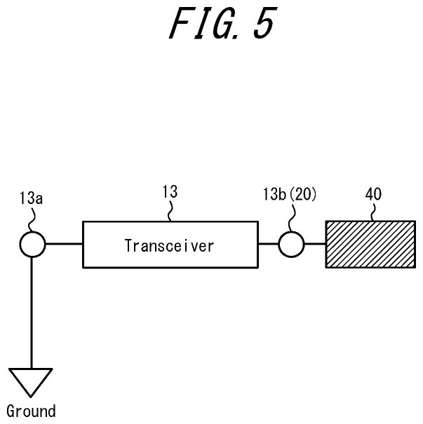

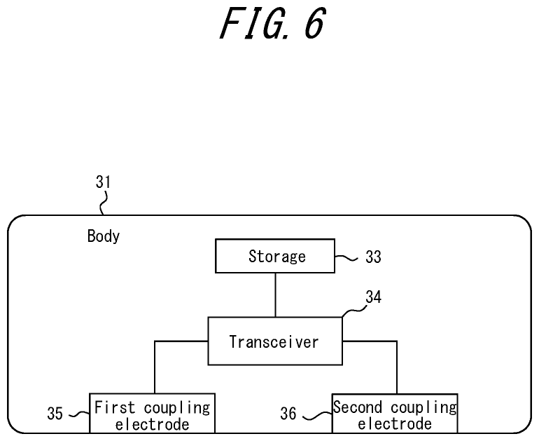

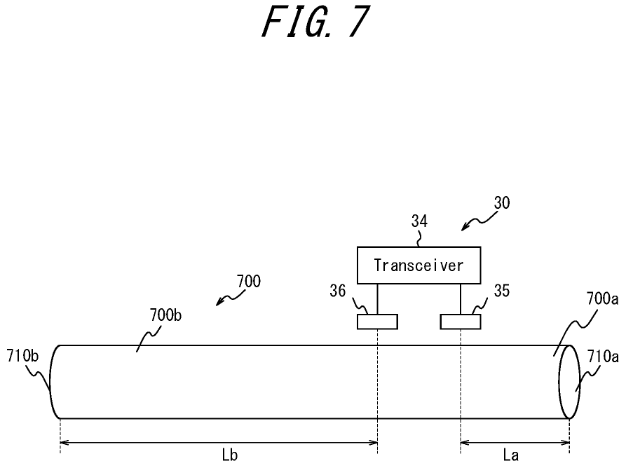

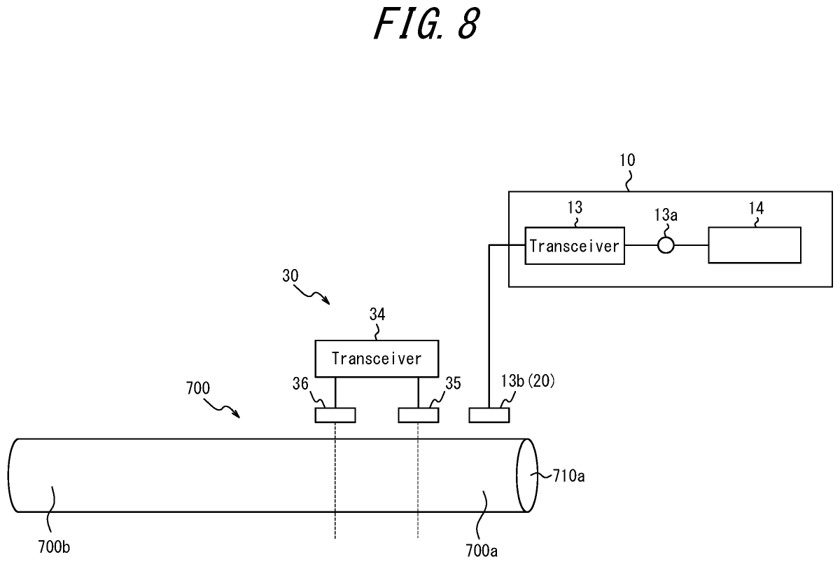

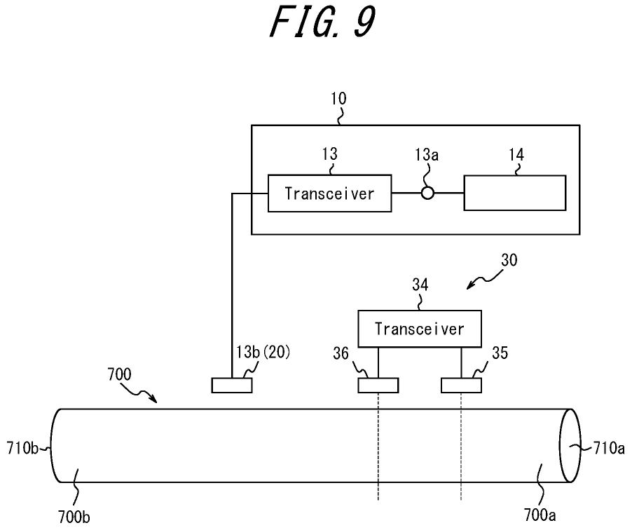

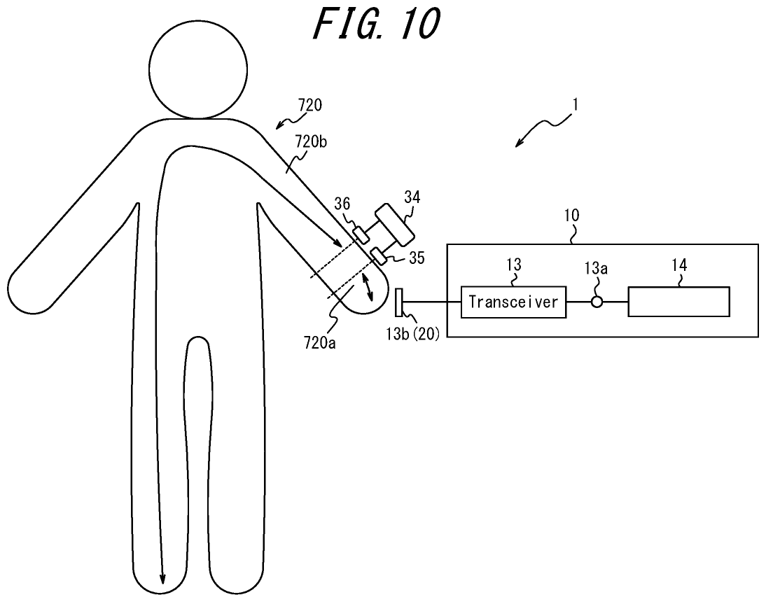

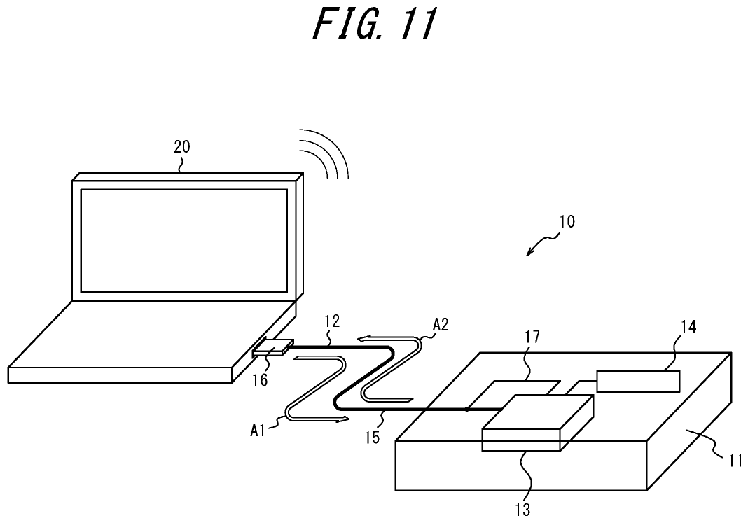

At this time, as illustrated in FIG. 4, the transceiver 13 inputs a high-frequency signal to the terminal line 14, which has an electrical length of 90 degrees, i.e. one quarter of the wavelength of the high-frequency signal to be transmitted, and the end 14b of which is open. Consequently, a standing wave is generated in the terminal line 14, with maximum voltage amplitude and zero current amplitude at the end 14b and zero voltage amplitude and maximum current amplitude at the end 14a, and current flows to the end 14a. In other words, when the terminal line 14 has an electrical length of 90 degrees, the voltage amplitude at the end 14a is zero, but current flows. Hence, as illustrated schematically in FIG. 5, the end 14a functions as though it were virtually short circuited to ground. The first input/output terminal 13a connected to the terminal line 14 can thus be considered a short-circuit terminal that is virtually connected to ground.

As illustrated in FIG. 4, the current that flows into the first input/output terminal 13a is maximized when the electrical length of the terminal line 14 is 90 degrees, i.e. when the signal input from the end 14a of the terminal line 14 connected to the first input/output terminal 13a of the transceiver 13 is reflected at the other end 14b and returns so that the phase of the reflected wave is 180 degrees. Consequently, electric field communication is most efficient when the electrical length of the terminal line 14 is 90 degrees. During electric field communication, however, a certain advantage in high-frequency transmission is still obtained by the electrical length of the terminal line 14 being within a range of ±45 degrees of 90 degrees, i.e. with the phase of the reflected wave being in a range greater than 90 degrees and less than 270 degrees. It thus suffices for the terminal line 14 to have an electrical length of substantially 90 degrees, which includes a range of ±45 degrees from 90 degrees. The terminal line 14 may have an electrical length of ((2n+1)×90±45) degrees, where n is an integer of at least 0. When the terminal line 14 has an electrical length of ((2n+1)×90±45) degrees, the terminal line 14 functions as a virtual ground by the same principle as described with reference to FIG. 4.

Next, the configuration of the electric field communication terminal 30 is described. As described above, the electric field communication terminal 30 includes the body 31 and the wearable portion 32.

FIG. 6 is a functional block diagram schematically illustrating an example of the configuration of the body 31 of the electric field communication terminal 30. The body 31 includes a storage 33, a transceiver 34, a first coupling electrode 35, and a second coupling electrode 36.

The storage 33 stores various information. The storage 33 may, for example, be configured by an integrated circuit (IC) chip. For example, the storage 33 stores unique identification information (ID) in one-to-one association with the electric field communication terminal 30. The ID may, for example, be in one-to-one association with the user of the electric field communication terminal 30.

During electric field communication with the electronic device 20, the transceiver 34 transmits and receives high-frequency signals (or high-frequency power) between 10 kHz and 10 GHz, for example. The functions of the transceiver 34 may be similar to those of the transceiver 13 described above. The transceiver 34 is coupled electrically with the first coupling electrode 35 and the second coupling electrode 36.

The first coupling electrode 35 and the second coupling electrode 36 are coupling electrodes that couple to a human body, which is a dielectric, when the user is wearing the electric field communication terminal 30 (wearing state). In other words, the first coupling electrode 35 and the second coupling electrode 36 are disposed at positions in the body 31 that are in contact with the user in the wearing state.

The electric field communication terminal 30 can perform electric field communication by the same principle as described with reference to FIG. 4. When performing electric field communication, the transceiver 34, the first coupling electrode 35, and the second coupling electrode 36 have functions respectively corresponding to the transceiver 13, the second input/output terminal 13b, and the first input/output terminal 13a in FIG. 4. A portion of the human body in contact with the first coupling electrode 35 (such as the distal side of the wrist) functions as the transmission medium 40 in FIG. 4, and a portion of the human body in contact with the second coupling electrode 36 (the entire body excluding the distal side of the wrist) functions similarly to the terminal line 14 in FIG. 4.

Here, the principle by which the human body functions as a transmission medium and a terminal line is described. FIG. 7 schematically illustrates the state in which the electric field communication terminal 30 is coupled to a dielectric 700. In FIG. 7, the dielectric 700 is illustrated schematically as being cylindrical.

As illustrated in FIG. 7, the cylindrical dielectric 700 has a first bottom (first end) 710a and a second bottom (second end) 710b. The height of the cylindrical dielectric 700 is greater than the diameter of the bottoms (a first bottom 710a and a second bottom 710b) of the dielectric 700. The height direction of the cylinder is also referred to as the longitudinal direction.

The electric field communication terminal 30 couples to the dielectric 700 so that the first coupling electrode 35 and the second coupling electrode 36 are side-by-side in the longitudinal direction of the dielectric 700. Here, it is assumed that the first coupling electrode 35 is coupled to be closer to the first bottom 710a, and the second coupling electrode 36 is coupled to be closer to the second bottom 710b.

In the dielectric 700 to which the electric field communication terminal 30 is coupled, the region from the position at which the first coupling electrode 35 is coupled towards the first bottom 710a is referred to as a first region 700a, and the region from the position at which the second coupling electrode 36 is coupled towards the second bottom 710b is referred to as a second region 700b. The height of the first region 700a (the length in the longitudinal direction) is referred to as La, and the height of the second region 700b as Lb. By the user coupling the first coupling electrode 35 and the second coupling electrode 36 of the electric field communication terminal 30 to the dielectric 700 at the below-described predetermined positions, the first region 700a functions as a transmission medium, and the second region 700b functions as a terminal line.

Here, the predetermined positions for the first region 700a to function as a transmission medium and the second region 700b to function as a terminal line are described. The electric field communication terminal 30 is coupled to a position on the dielectric 700 such that the length Lb is an electrical length of ((2n+1)×90) degrees. If the length Lb is an electrical length of ((2n+1)×90) degrees, then the electric field communication system 1 capable of electric field communication is established by the electric field communication terminal 30, the dielectric 700, and the electronic device 20, which has the connection apparatus 10 connected thereto, upon the first region 700a coupling with the schematically illustrated second input/output terminal 13b formed by the electronic device 20, as illustrated in FIG. 8. In this case, by the principle explained with reference to FIG. 5, a standing wave is generated with a maximum voltage amplitude and zero current amplitude at the second bottom 710b of the second region 700b and zero voltage amplitude and maximum current amplitude at the end of the second region 700b where the second coupling electrode 36 is coupled. From the transceiver 34, current thus flows towards the second region 700b of the dielectric 700 through the second coupling electrode 36, and current flows towards the first region 700a through the first coupling electrode 35. Consequently, the electric field communication terminal 30 can use the first region 700a as a transmission medium to communicate with the connection apparatus 10 through the electronic device 20, which functions as an electric field antenna. In this way, the second region 700b has a similar function to that of the terminal line 14 illustrated in FIG. 4.

As explained with reference to FIG. 4, a certain advantage in high-frequency transmission is still obtained when the electrical length of the terminal line 14 is within a range of ±45 degrees of 90 degrees, i.e. when the phase of the reflected wave is greater than 90 degrees and less than 270 degrees. Therefore, coupling at a position such that the length Lb becomes an electrical length in a range of ((2n+1)×90±45) degrees is sufficient for the second region 700b to function as a terminal line.

Here, the electric field communication terminal 30 is coupled to a position on the dielectric 700 such that the length La is an electrical length of (2n×90) degrees. If the length La were also an electrical length of ((2n+1)×90) degrees like the length Lb, then the first region 700a would function as a terminal line and the second region 700b would function as a transmission medium upon the second region 700b coupling with the second input/output terminal 13b, as illustrated in FIG. 9. In other words, in this configuration, either the first region 700a or the second region 700b can function as a terminal line.

However, when the second input/output terminal 13b is coupled to the dielectric 700 at a position such that the length La of the first region 700a is an electrical length of (2n×90) degrees, the standing wave illustrated in FIG. 4 is not generated at the end on the side where the first coupling electrode 35 of the first region 700a is coupled. Consequently, the first region 700a does not function as a terminal line, and no virtual ground is formed, even if the second region 700b couples to the second input/output terminal 13b, as illustrated in FIG. 9. This prevents the establishment of communication between the electric field communication terminal 30 and the connection apparatus 10.

In this way, when the electric field communication terminal 30 is coupled at a position such that the length La of the first region 700a is an electrical length of (2n×90) degrees and the length Lb of the second region 700b is an electrical length of (2(n+1)×90) degrees, the second region 700b of the dielectric 700 functions as a terminal line, whereas the first region 700a of the dielectric 700 does not function as a terminal line. Hence, the electric field communication terminal 30 establishes communication when the second input/output terminal 13b configured by the electronic device 20 is coupled to the first region 700a but does not establish communication when the second input/output terminal 13b is coupled to the second region 700b.

In this way, by the electric field communication terminal 30 coupling to a predetermined position of the dielectric 700, a region allowing establishment of communication and a region not allowing establishment of communication upon coupling with the electronic device 20, which is the second input/output terminal 13b, can be formed in the dielectric 700. In other words, the region allowing establishment of communication in the dielectric 700 can be restricted in this way. The region allowing establishment of communication can therefore be restricted when the electric field communication terminal 30 is coupled at the predetermined position on the dielectric 700. This reduces the likelihood of unintended communication and facilitates prevention of unintended information leaks. The electric field communication terminal 30 in the present embodiment improves security with respect to this point.

It suffices for the electric field communication terminal 30 to be coupled at a position where the length La of the first region 700a is such that no standing wave is generated in the first region 700a. It thus suffices for the electric field communication terminal 30 to be coupled at a position such that the length La is an electrical length in a range of (2n×90±45) degrees.

FIG. 10 illustrates an example of the electric field communication system 1 configured by coupling the electric field communication terminal 30 to a human body 720, which is a dielectric. As illustrated in FIG. 10, the first coupling electrode 35 and the second coupling electrode 36 are coupled to the human body 720 by the electric field communication terminal 30 being attached to the wrist or the like of the human body 720, for example. At this time, the first coupling electrode 35 and the second coupling electrode 36 couple to the human body 720 so as to be side-by-side in a direction from the torso side towards the distal side of the arm. The electric field communication terminal 30 may be formed as a wristband, an armband, or the like so as to be attachable to the wrist, the arm, or other body part when the electric field communication terminal 30 is coupled to the human body 720.

When the electric field communication terminal 30 is coupled to the human body 720, the electric field communication terminal 30 uses an electric field signal of a predetermined frequency so that the region from the first coupling electrode 35 coupled on the distal side to the end (for example, the fingertip) becomes the first region 700a illustrated in FIG. 7, and the region from the second coupling electrode 36 on the torso side to the entire arm, torso, and leg becomes the second region 700b illustrated in FIG. 7. The predetermined frequency may, for example, be 13.56 MHz. When the frequency of the electric field signal is 13.56 MHz, then coupling the second coupling electrode 36 to the human body 720 on the torso side near a wrist yields an electrical length of approximately 90 degrees as the length of the second region and an electrical length of less than 45 degrees as the length of the first region, supposing that the human body 720 is a typical adult height (such as 170 cm). Hereinafter, the frequency of the signal used by the electric field communication terminal 30 is assumed to be 13.56 MHz. Furthermore, the region from the first coupling electrode 35 on the distal side to the end (for example, the fingertip) is referred to as the distal side 720a of the human body 720, and the region from the second coupling electrode 36 on the torso side to the entire arm, torso, and leg is referred to as the torso side 720b of the human body 720.

When a fingertip, for example, of the human body 720 on which the electric field communication terminal 30 is worn touches the electronic device 20, then a standing wave is generated on the torso side 720b of the human body 720, forming a virtual ground. In other words, the torso side 720b functions as a terminal line. The distal side 720a functions as a transmission medium. Electric field communication is thus achieved between the connection apparatus 10 and the electric field communication terminal 30 via the human body 720, which functions as a transmission medium.

In the present embodiment, the distal side 720a does not function as a terminal line, and hence communication is not established, when the torso side 720b of the human body 720 on which the electric field communication terminal 30 is worn couples to the second input/output terminal 13b. In other words, the electric field communication system 1 according to the present embodiment allows electric field communication while reducing the likelihood of unintended communication, thereby facilitating prevention of unintended information leaks and improving security.

Next, with reference to FIG. 11, an example of operations for the electronic device 20, to which the connection apparatus 10 is connected, to function as an electric field antenna is described. In this example, the electronic device 20 that functions as an electric field antenna is described as transmitting high-frequency signals.

The transceiver 13 of the connection apparatus 10 is controlled by a driver or an application installed on the electronic device 20. When the electronic device 20 to which the connection apparatus 10 is connected transmits high-frequency signals, for example, by electric field communication, then a control signal for transmitting high-frequency signals is transmitted from the controller of the electronic device 20 to the transceiver 13 (arrow A1 in FIG. 11). The control signal is transmitted to the transceiver 13 through the signal wire of the cable 15.

The transceiver 13 transmits an output signal, related to the high-frequency signal to be transmitted by electric field communication, from the signal wire 17 for electric field communication based on the control signal received from the electronic device 20. The output signal transmitted from the signal wire 17 for electric field communication is transmitted to the housing of the electronic device 20 through the ground or shield wire of the cable 15 (arrow A2 in FIG. 11).

In this way, the output signal is transmitted to the housing (ground) of the electronic device 20 and is emitted from the housing (ground) of the electronic device 20 as an electric field near the housing. The electronic device 20 thus functions as an electric field antenna.

The electronic device 20 can receive a high-frequency signal in the reverse way from the above-described transmission. In other words, when the electronic device 20 that functions as an electric field antenna receives a high-frequency signal through the transmission medium, the high-frequency signal is transmitted through the ground or shield wire of the cable 15 from the signal wire 17 for electric field communication to the transceiver 13. The transceiver 13 transmits a received signal based on the received high-frequency signal to the electronic device 20 through the signal wire of the cable 15. The electronic device 20 can execute predetermined processing based on the received signal.

For example, as illustrated in FIG. 3, electric field communication is achieved by the principle explained with reference to FIG. 4 through FIG. 10 when a user wearing the electric field communication terminal 30 touches the electronic device 20, to which the connection apparatus 10 is connected, with a hand. The electronic device 20 can thus acquire information stored in the storage 33 of the electric field communication terminal 30, for example. When an ID is stored in the storage 33 of the electric field communication terminal 30, for example, the electronic device 20 can acquire information related to the ID by electric field communication. Suppose, for example, that the controller of the electronic device 20 executes a PC login process based on the ID. The controller of the electronic device 20 can read the ID stored in the storage 33 of the electric field communication terminal 30 by the user wearing the electric field communication terminal 30 and touching the electronic device 20. The controller can then execute the login process when judging that the ID is a legitimate ID with login authority. In other words, the user can log in by touching the electronic device 20 instead of inputting a password or the like, for example.

As described above, the connection apparatus 10 can add an electric field communication function to the electronic device 20 by being connected to the electronic device 20. The connection apparatus 10 is therefore capable of easily adding an electric field communication function to an existing electronic device that does not have an electric field communication function.

The connection apparatus 10 is insertable into the electronic device 20. When it is not desirable to add an electric field communication function to the electronic device 20, for example, the connection apparatus 10 may therefore be removed from the electronic device 20. The connection apparatus 10 can therefore selectively add an electric field communication function to the electronic device 20.

The electronic device 20 has been described as a PC in the above embodiment, but the electronic device 20 is not limited to being a PC and may be any other electronic device. The electronic device 20 may, for example, be a copy machine, a printer, an image scanner, a facsimile, or the like, or may be implemented as one electronic device combining all of these functions, i.e. an all-in-one device.

In the connection apparatus 10, the length of the cable 15 may be shortened, the signal wire inside the cable may be configured on a substrate, and the substrate of the connection apparatus 10 may be connected directly to the connection terminal 16.

Embodiments of the present disclosure have been described in detail. A person of ordinary skill in the art, however, could make modifications or substitutions to the above embodiments without departing from the scope of the present disclosure. In other words, the present disclosure is not limited to the above embodiments, and a variety of modifications and changes are possible. For example, the functions and the like included in the various components may be reordered in any logically consistent way. Furthermore, components may be combined into one or divided.

The matter disclosed in the present disclosure is not intended to be all-encompassing. That is, the present disclosure does not deny the existence of subject matter not claimed in the present disclosure, i.e. the existence of subject matter of a later divisional application or subject matter to be added by amendment.

The present disclosure includes examples for the purpose of illustration but is not to be considered limited by the content of such examples.

### REFERENCE SIGNS LIST

1 Electric field communication system
10 Connection apparatus
11, 31 Body
12 Connector
13 Transceiver
13a First input/output terminal
13b Second input/output terminal
14 Terminal line
14a, 14b End
15 Cable
16 Connection terminal
17 Signal line for electric field communication
20 Electronic device
30 Electric field communication terminal
32 Wearable portion
33 Storage
34 Transceiver
35 First coupling electrode
36 Second coupling electrode
40 Transmission medium
700 Dielectric
700a First region
700b Second region
710a First bottom
710b Second bottom
720 Human body
720a Distal side
720b Torso side

1. A connection apparatus comprising:
a connection terminal connectable to an electronic device;
a cable connected to the connection terminal;
a transceiver connected to the cable and configured to control transmission and reception of high-frequency signals or high-frequency power;
a terminal line connected to the transceiver and having an electrical length of substantially 90 degrees; and
a signal wire for electric field communication, the signal wire being connected from the transceiver to a ground of the cable.

2. The connection apparatus of claim 1, wherein the connection terminal is insertable into the electronic device.
